(19) United States
(12) Patent Application Publication
(10) Pub. No.: US 2021/0027396 A1
(43) Pub. Date: Jan. 28, 2021

(54) SYSTEM AND METHOD FOR DISCOVERING HOBBIES IN A SOCIAL NETWORK

(71) Applicant: Hamidah Nalwoga, Methuen, MA (US)

(72) Inventor: Hamidah Nalwoga, Methuen, MA (US)

(21) Appl. No.: 17/068,111

(22) Filed: Oct. 12, 2020

Related U.S. Application Data
(60) Provisional application No. 63/051,881, filed on Jul. 14, 2020.

(51) Int. Cl. G06Q 50/00; G06Q 30/02; G06Q 10/02; G06Q 20/08; G06F 16/28

(52) U.S. Cl. CPC G06Q 50/01; G06Q 30/0204; G06Q 50/205; G06Q 20/085; G06F 16/285; G06Q 10/02

(57) ABSTRACT

The present disclosure relates to a system and method for discovering and fulfilling hobbies. The system according to the present invention provides for an online social networking platform that allows a member to meet new people having similar interests and hobbies. The system can receive interests from each member and based on the interests can choose new people that can be put onto a discovery page associated with each user. Moreover, discloses the system provides for hosting the services and advertising services based on the interests of the user, wherein the services can be displayed on the discovery page.

### CROSS-REFERENCE TO RELATED APPLICATIONS

This application claims priority to the U.S. provisional patent application Ser. No. 63/051,881 filed on Jul. 14, 2020, which is incorporated herein by reference in its entirety.

### FIELD OF INVENTION

The present disclosure relates to a system and method for social networking, and more particularly, the present invention relates to a system and method discovering and fulfilling hobbies through a social network.

### BACKGROUND

Online platforms for social networking have become quite popular. These platforms allow a user to stay connected with their friends, relatives, and colleagues. The known platforms allow members to post images, stories, and like that are visible to the members connected to the user, wherein the connected members can respond to the post. However, the known platforms generally aim to satisfy the social needs of members by providing a way to interact and share moments with close ones.

Hobbies are an essential part of life and play an important role in the personal and intellectual development of an individual. Hobbies also provided for socializing and removing stress leading to a happier life. However, busier life had made people overlook their hobbies. Additionally, lack of resources for fulfilling the hobbies also a factor that the people neglect what they love to do.

Thus, a need is appreciated for a system and method that allows individuals to discover and fulfill their hobbies.

### SUMMARY OF THE INVENTION

The principal object of the present invention is therefore directed to a system and method for discovering and fulfilling hobbies.

It is another object of the present invention to provide an online social networking platform for meeting new people.

It is still another object of the present invention to provide online and offline activities related to hobbies of the members.

It is a further object of the present to provide for groups on the online social networking platform.

In one aspect, disclosed is a computer implemented method for discovering and fulfilling hobbies. The method comprises receiving, by a computing device, at least one interest from each of the plurality of users and presenting, by the computing device, a discovery page to each user of the plurality of users. The discovery page includes a list of users having common interests, the common interests related to the at least one interest, a list of services based on the at least one interest, and a list of groups based on the at least one interest.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram of the system, according to an exemplary embodiment of the present invention.

FIG. 2 shows a server, according to an exemplary embodiment of the present invention.

FIG. 3 is a flowchart showing a registration module, according to an exemplary embodiment of the present invention.

FIG. 4 is a flowchart showing a discovery module, according to an exemplary embodiment of the present invention.

FIG. 5 is a flowchart showing an activities module, according to an exemplary embodiment of the present invention.

FIG. 6 is a flowchart showing a groups module, according to an exemplary embodiment of the present invention.

FIG. 7 is a flowchart showing an interface module, according to an exemplary embodiment of the present invention.

FIG. 8 shows an interface of a discovery page, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

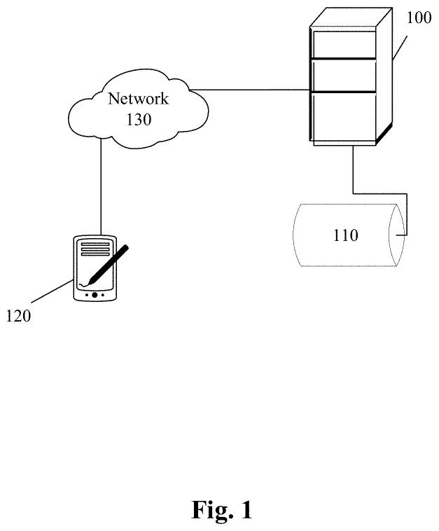

Disclosed is a system and method for providing an online social networking platform that allows its members to discover and fulfill their hobbies. Now referring to FIG. 1, which is a block diagram showing the system 100 connected to a member database 110. The system 100 can further be connected to at least one user device 120 through the network 130. The system 100 according to the present invention provides an online social networking platform for discovering and fulfilling hobbies. The member database 110 can store the member details, including their profiles having interests can be indexed in a searchable table. A skilled person will understand that although the FIG. 1 shows, the system 100 and the member database 110 as separate objects, it is possible that the member database 110 can be configured into the system 100. According to certain embodiments, the user device 120 can be a computing device having a display and networking circuitry. Examples of the computing device include a smartphone, laptop, desktop, tablet computer, personal digital assistant (“PDA”), or the likes. The computing device can include an operating system, such as Android, Windows, Linux, or iOS.

The system 100 can connect to the user device 120 through the network 130. The network 130 can be wired or wireless. The wired network may include Digital Subscriber Line (DSL), coaxial cable lines, or optical fiber lines. The wireless network can be BLUETOOTH, Wi-Fi, Worldwide Interoperability for Microwave Access (WiMAX), an infrared channel, or satellite band. The wireless network may also include any cellular network standards used to communicate among mobile devices, including standards that qualify as 3G, 4G, or 5G. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. The geographical scope of the network 130 may vary widely and the network 130 can be a body area network (BAN), a personal area network (PAN), a local-area network (LAN), e.g. Intranet, a metropolitan area network (MAN), a wide area network (WAN), or the Internet.

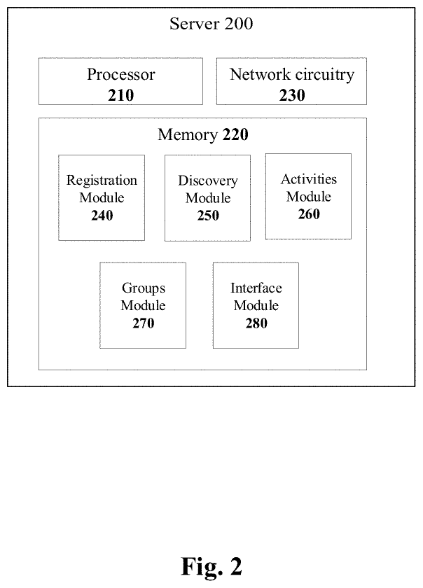

According to an embodiment of the present invention, system 100 may include a single or multiple, logically grouped servers. According to an exemplary embodiment, the servers may be geographically dispersed. One or more of the servers can include an operating system platform, for example, Windows, Unix, Linux, or Mac. An embodiment of the server 200 is shown in FIG. 2 having a processor 210, a memory 220, and a network circuitry 230, wherein the memory 220 and the network circuitry 230 are in electronic communication with the processor 210.

As shown in FIG. 2, the memory includes one or more modules according to the present invention which, when executed by the processor 210 causes the processor 210 to perform one or more functions of the disclosed method for providing an online social networking platform. The memory 220 includes a registration module 240, discovery module 250, an activities module 260, and groups module 270, an interface module 280.

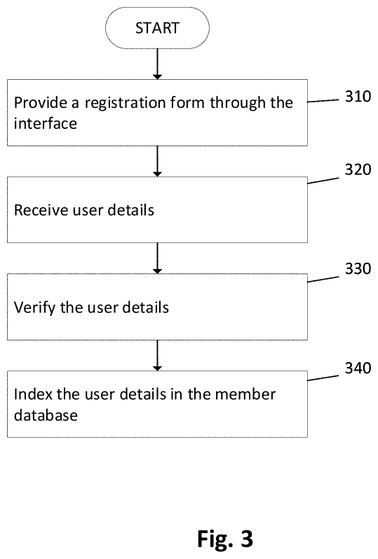

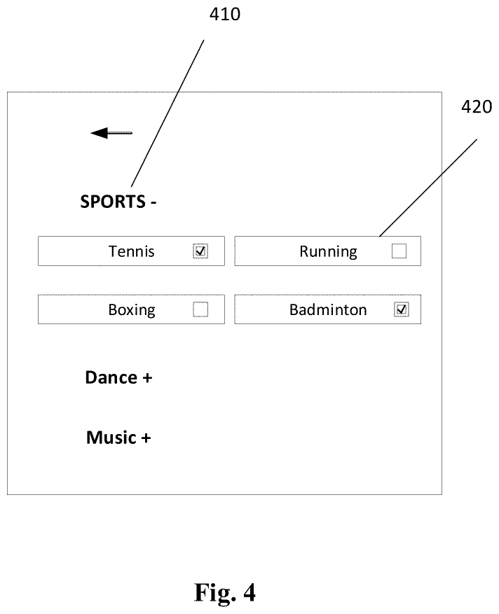

FIG. 3 shows an embodiment of the registration module 240. A user desiring to register with the disclosed online platform can download an interface from the server 200. The interface can be provided as application software that can be installed in a user device 120. The application software can be developed for Windows, Linus, Android, iOS, and any other known operating platform for mobile devices. The application software can be made available through a distribution service provider, for example, Google Play operated and developed by Google and the app store by Apple. In addition to the application software, a website-based interface can also be provided through the world-wide-web. At step 310, the user can be presented with a registration form, wherein the user can enter details, such as name, gender, age, username, profile avatar or photograph, and like details, at step 320. In particular, the registration form includes columns for the interest of the user. The interests could be related to hobbies, such as singing, dancing, arts, music. Moreover, the registration module can receive multiple interests from the user wherein the interests are ranked from high to low. For example, the user can be provided with the options to enter three interests in order of decreasing preference. The user can enter music as the first interest, guitar as the second interest, and singing as the third interest. The registration module may also allow a user to provide broad interests and specific interests as well. FIG. 4 shows an exemplary illustration of the registration page provided by interface module 280. As shown in FIG. 4, the interface module can provide broad categories 410 as list and specific entries 420 under each broad category as options. For example, the broad sports category can include options such as tennis, running, boxing, badminton, and the likes. The user can select the desired specific interests. The checkmarks against tennis and badminton show the selections by a user.

Upon receiving the user details, the registration module 240 can provide for verification of the user details, at step 330. Upon successful verification of the user, the registration module 240 can register the user with the system 100. The user on successful registration becomes a member of the disclosed online platform embodied by the system 100. The registration module can index the user details in the member's database 110, at step 340. The user details are indexed such as at least the interests of the user can be queried by the disclosed system 100. The member can assess and edit the user details stored in the member database in the form of a member profile. Furthermore, the registration module 240 can allow the member to edit his profile, including updating the profile picture. The member can also update their interests with new interests or change the order of old interests between high to low. Moreover, the registration module can allow the members to update their login details, including the password.

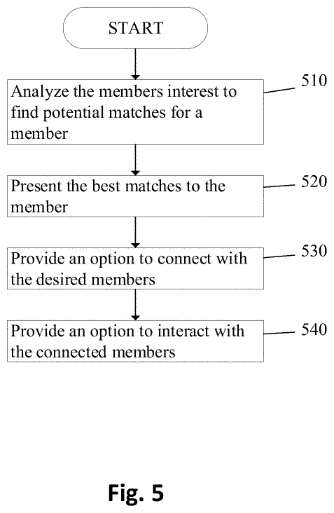

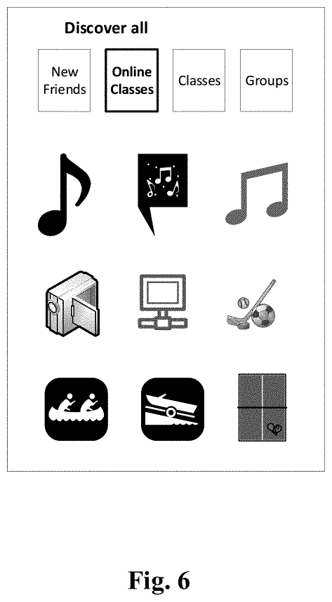

Referring to FIG. 5 which shows one implementation of the discovery module 250 for introducing to a member new people having interests like the member. The discovery module can receive the interests of a new member from the registration module. As explained above, a user provides, during the registration stage, his interests, and hobbies. The user is interested to meet people with similar interests to discover and fulfill his hobbies. The discovery module looks for members having similar interests and provide a list of members. First, based on the interests of a member, the discovery module can query the member's database to find members with similar interests. Moreover, the discovery module can analyze the activities of the members to find those members that could be a better match to the interests of the member, at step 510. The chosen members, at step 510, can be put on a discovery page of a member. An embodiment of the discovery page is shown in FIG. 6. The interface module can provide a discovery page having one or more tabs 610 that can be linked to subpages. The tabs include headings, such as “New friends” and “Online Classes”. On the subpage “New friends” the potential matches determined by the discovery module at step 510 can be shown, at step 520. The discovery page can show profile picture and the names of the members as thumbnails and the member can click on a thumbnail which opens a target page that includes the profile of the member associated with the thumbnail. Below each thumbnail or the target page can be provided nodes that allow the member to connect with the selected member, at step 530. The interface module can also provide a range of option for the members to interact, particularly for the new members to interact, such as chat box, at step 540.

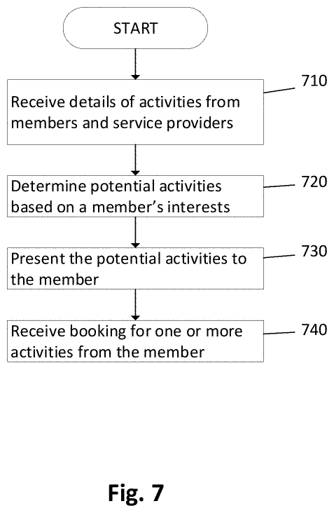

FIG. 7 shows an implementation of the activities module 260. The disclosed platform not only provides a platform where people with like interest can meet and interact but also a platform where services can be posted by members and service providers. The disclosed invention provides an opportunity for the members to earn by providing paid classes and advertise their services. For example, tutors, freelances, and the like can be benefitted by the present invention. The disclosed platform allows members to follow the service providers, their posts, share reviews, and like. The platform may also provide for verifying the service providers.

In one implementation the disclosed platform provides for conducting live online classes. Such classes can be interactive i.e. both attended and host can communicate. For example, a student can raise a hand and the teacher may allow the student to speak by activating the microphone of the student. The online classes allow specifying the number of participants that can participate in one session. Members can book in advance for the classes, and if the classes are full, people go on an automated waiting list. Confirmation about the booking including the waiting list can be sent to the participant. Moreover, the disclosed platform provides for receiving and settling payments between the participants and the host. For example, the platform can provide an escrow account that receives payment from the participant at the time of booking and pay the money to the host only after the class. The platform can also provide a procedure for cancelation and refund. The disclosed platform also allows for the sharing of a screen and documents among the participants and host.

The platform can receive details of the services from members and service providers willing to host their services on the platform, at step 710. The services can be integrated with the platform or can also be offline. The services hosted by the platform are chiefly related to the interests of the members on the platform. The details of the services can include a description of the services, charges, timings, duration, whether online or offline, location in case the service is offline, number of participants that can be admitted in a session. For each member, the disclosed platform can determine the potential activities the user may be interested in, at step 720. Potential activities can be determined based on the interests of the members. The interface module can put the relevant activities on the discovery page of the members, at step 730. For the offline services, the relevant activities can also be based on the location of the service provider and the location of the members. The activities module may also provide for booking of the services by the members and payments. The interface module can provide a page which shows the summary of the bookings including the waiting list.

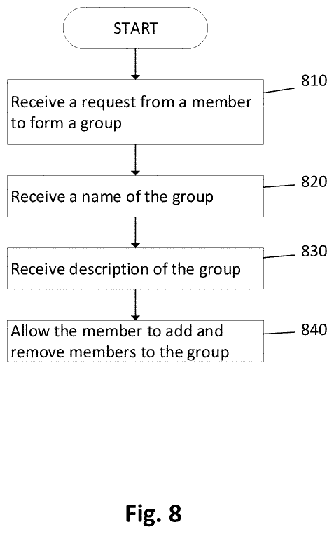

FIG. 8 is a flowchart showing one implementation of the group module 270. The group module provides for making groups. Any member of the platform can form a group. To make a group, the group module can receive a request from a member, at step 810. The group module can receive the name of the group, at step 820. The group module can receive the description of the group, at step 830. The description includes the objective of the group, which members can join the group, interests as keywords for searching the group, and like. The group module also shows the available groups on the discovery page. Groups relevant to a particular member can be determined by matching the interests of the member with the description of the group. For example, members having music as a broad interest can be presented with a group related to guitar. The group allows a member to communicate with many other people at the same time. The members of the group can participle in a common activity. The group module can provide for live streaming of the common activities among members of the group. The member forming a group can add and remove members, at step 840.

What is claimed is:

1. A computer implemented method for discovering and fulfilling hobbies, the method comprises:
receiving, by a computing device, at least one interest from each of the plurality of users; and
presenting, by the computing device, a discovery page to each user of the plurality of users, the discovery page comprising:
a list of users having common interests, the common interests related to the at least one interest,
a list of services based on the at least one interest,
a list of groups based on the at least one interest.

2. The method of claim 1, wherein the method further comprises:
receiving, by the computing device, from a user, a selection of one or more users from the list of users; and
associating, by the computing device, the one or more users to the user.

3. The method of claim 1, wherein each user of the list of users represented as a thumbnail, the thumbnail comprising a profile picture.

4. The method of claim 1, wherein the method further comprises the step of:
providing, by the computing device, a registration interface, the registration interface comprising a list of broad interest categories and a list of subcategories associated with each category of the list of broad interest categories.

5. The method of claim 1, wherein the method comprises a step of providing an integrated platform for hosting the services, the integrated platform configured to:
receive a booking for a service;
provide an interactive online conference wherein a host and participants can interact and share documents; and
selectively activating a mic, in the interactive online conference, by the host, of one of the participants.

6. The method of claim 5, wherein the integrated platform is further configured to:
receive fee for the booking;
hold the fee till the service is availed; and
upon availing the service, pay the fee to a service provider.

7. The method of claim 1, wherein the method further comprises the steps of:
receiving, by the computing device, a location of the plurality of users; and
receiving, by the computing device, a location of a service provider,
wherein the list of services is based on the location of the plurality of users and the location of the service provider.

8. A system discovering and fulfilling hobbies, the system comprising a server including a processor and a memory in communication with the processor, wherein the memory stores a set of instructions executable by the processor, the set of instructions when executed by the processor, cause the processor to:
receive at least one interest from each of the plurality of users; and
present a discovery page to each user of the plurality of users, the discovery page comprising:
a list of users having common interests, the common interests related to the at least one interest,
a list of services based on the at least one interest, and
a list of groups based on the at least one interest.
